(19) United States
(12) Patent Application Publication
(10) Pub. No.: US 2018/0132291 A1
(43) Pub. Date: May 10, 2018

(54) SIP Call Continuity Upon Failure

(71) Applicant: T-Mobile USA, Inc., Bellevue, WA (US)

(72) Inventors: Kalyan Kalepu, Sammamish, WA (US); Joel Arends, Renton, WA (US); Nassereddine Sabeur, Seattle, WA (US); Boris Antsev, Bothell, WA (US)

(21) Appl. No.: 15/344,015

(22) Filed: Nov. 4, 2016

(51) Int. Cl. H04W 76/02; H04L 29/06; H04W 24/04

(52) U.S. Cl. CPC H04W 76/027; H04W 80/04; H04W 24/04; H04L 65/1069

(57) ABSTRACT

A P-CSCF (Proxy Call Session Control Function) is a component that services as an entry point into an IMS (IP multimedia subsystem) communications system. During a P-CSCF discovery process, a device is configured to obtain both an identification of a primary P-CSCF and an identification of a secondary P-CSCF. When initiating an IMS data session, a device first attempts to set up the session by communicating with the primary P-CSCF. If that fails, the device then attempts to set up the session by communicating with the secondary P-CSCF.

### BACKGROUND

Mobile communications are increasingly provided by packet-based communication systems rather than legacy circuit-switched systems. A communication infrastructure known as IMS (IP multimedia subsystem), for example, is often used within cellular communication systems for providing voice and other types of communications, including messaging, video, and other types of services and communications.

Logical components of an IMS system are typically implemented by physical and/or virtual servers and other computer-based devices. Devices such as this may fail from time to time, or may be taken offline for maintenance. In addition, certain servers may at times become inaccessible due to network communication issues.

However, a communication device such as a mobile phone may rely upon the ability to communicate with a particular server in order to initiate a data communications session using IMS services. Accordingly, it is useful to provide mechanisms for mitigating the consequences of any server becoming inaccessible.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram of a system that includes IMS (IP multimedia subsystem) services and that provides P-CSCF (proxy call session control function) backup.

FIGS. 2 and 3 are diagrams illustrating example call flows, demonstrating P-CSCF backup.

FIG. 4 is a flow diagram illustrating an example method of implementing P-CSCF backup within a communication device.

FIG. 5 is a flow diagram illustrating an example method of providing information regarding primary and secondary P-CSCFs to a requesting communication device.

FIG. 6 is a block diagram of an example communication device that may be configured to implement the techniques described herein.

FIG. 7 is a block diagram of an example computing device that may be configured to implement various functionality of an IMS infrastructure.

### DETAILED DESCRIPTION

The described implementations provide devices, systems, and methods that allow a communication device to initiate an IMS communication session despite the failure or inaccessibility of certain components of the IMS system.

In accordance with techniques that are described in more detail below, a mobile device when attaching to an IMS network obtains addresses for both primary and secondary P-CSCFs (proxy call session control functions). When initiating a communication session, the mobile device attempts first to communicate with the primary P-CSCF. For example, the mobile device may send a SIP (session initiation protocol) INVITE message to the IP (internet protocol) address of the primary P-CSCF. If there are no failures or errors, the primary P-CSCF responds in accordance with standardized IMS protocols and the communication session is established as a matter of course.

In some cases, however, the mobile device may encounter an error when attempting to communicate with the primary P-CSCF. For example, the mobile device in some situations may fail to receive a response to the INVITE from the primary P-CSCF. As another example, the mobile device may receive a response, but the response may indicate that there has been an error, and that the P-CSCF is unable to initiate the requested communication session.

Upon encountering such an error when trying to initiate a communication session through the primary P-CSCF, the mobile device is configured to then attempt communications with the secondary P-CSCF and to initiate and complete the communication session through the secondary P-CSCF.

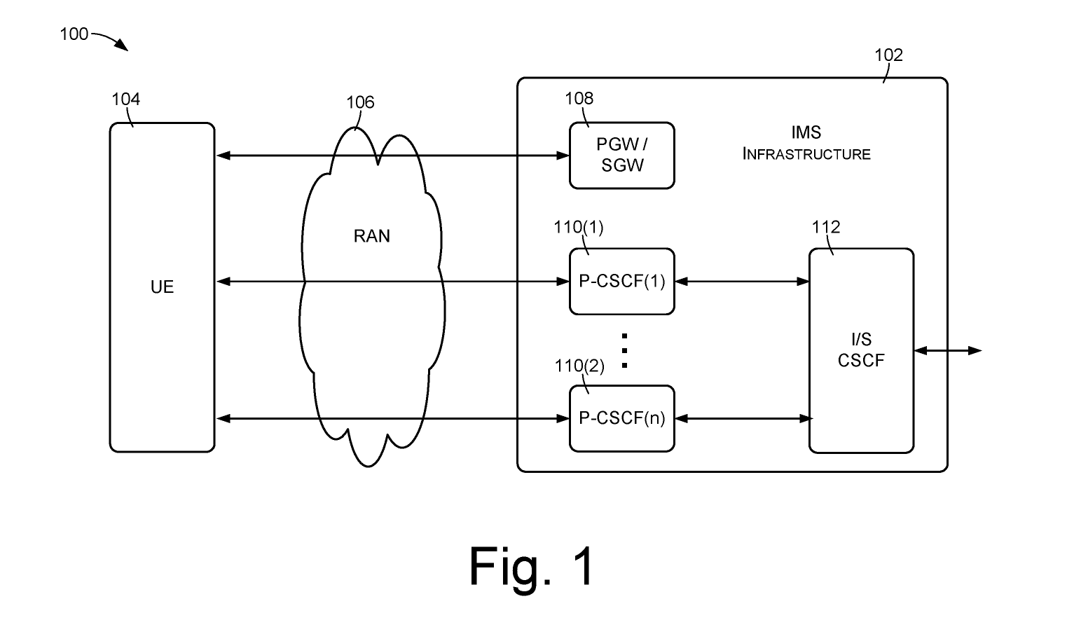

FIG. 1 shows a portion of a mobile communication system 100 in which the described techniques may be implemented. In certain implementations, for example, the mobile communication system 100 may comprise a cellular communication system comprising multiple geographically dispersed base stations that provide radio communications with multiple mobile devices.

The system 100 comprises an IMS (IP multimedia subsystem) communications infrastructure 102 that provides communications between multiple mobile user equipment (UE) devices 104, only one of which is shown in FIG. 1 for purposes of illustration and discussion. The techniques described herein relate to making calls and/or initiating communication sessions from a device such as the mobile UE 104.

In the described embodiment, the IMS communications infrastructure 102 may be implemented in accordance with the LTE (Long-Term Evolution) standard for high-speed data communications between mobile devices. Components of the IMS infrastructure 102 most relevant to the current discussion are shown in FIG. 1. In practice, the IMS infrastructure 102 will have various other components and functions as defined by various standards. The components shown in FIG. 1 represent logical functionality that is implemented by computing devices such as computer servers.

The UE 104 may comprise a device having wireless network communication capabilities such as a mobile computing or communication device, a smartphone, a telephone handset, a headset, a wearable device, a computer, a personal computer, a desktop computer, a laptop computer, a tablet computer, etc. The communication capabilities of the UE 104 may include Wi-Fi capabilities, cellular or other telephony capabilities, and/or other wired or wireless network communication capabilities. The techniques described herein assume that the UE 104 is functioning as an originating device to initiate a communication session, which is also referred to as a call session or IMS session in the IMS environment.

The UE 104 communicates with the IMS infrastructure 102 through a wireless access network 106, which is also referred to as an air interface or in the LTE environment as a radio access network (RAN).

Relevant components of the IMS infrastructure 102 include a packet data network gateway (PGW) and/or a serving gateway (SGW), which are collectively referred to herein as a PGW/SGW 108. Functions or actions attributed herein to the PGW/SGW 108 may be performed in practice by either of the PGW and SGW, or by the PGW and SGW in cooperation with each other. In implementation, the LTE infrastructure 102 may include multiple PGWs and SGWs.

The components of the infrastructure 102 also include multiple P-CSCFs (proxy call session control functions) 110. The components of the infrastructure 102 further include an I-CSCF (interrogating call session control function) and/or an S-CSCF (serving call session control function), which are collectively referred to herein as an I/S-CSCF 112. In implementation, the LTE infrastructure 102 may include multiple I-CSCFs and S-CSCFs. Functions or actions attributed herein to the I/S-CSCF 112 may be performed in practice by an I-CSCF or S-CSCF of the IMS infrastructure 102, or by an I-CSCF and S-CSCF in cooperation with each other.

A P-CSCF 110 acts as a gateway to the IMS infrastructure 102 and is responsible for, among other things, establishing security associations with UEs, registering UEs, and identifying an I/S-CSCF for use by a requesting UE. In addition, SIP (session initiation protocol) messaging flows through the P-CSCF.

The PGW/SGW 108 has several functions, of which the most relevant for purposes of the current discussion is that of providing IP (Internet Protocol) addresses to UEs. For example, the PGW/SGW 108 may in some situations allocate the IP addresses of UEs. The PGW/SGW 108 may additionally provide, to a requesting UE, the IP address of a P-CSCF 110 that is to be used by the UE.

The I/S-CSCF 112 is responsible for controlling various services within the LTE infrastructure 102, including routing session requests to S-CSCFs of called parties.

A UE 104 attaches to an LTE network by communicating with the PGW/SGW 108 to establish a bearer. During communications with the PGW/SGW 108, the PGW/SGW provides to the UE 104 an IP address of a primary P-CSCF 110 and a secondary P-CSCF 110. During subsequent communications, such as when the UE 104 initiates voice calls or other communication sessions, a P-CSCF 110 is the initial point of contact for the UE 104. Prior to attempting to place a call or start a session, the UE 104 registers with designated P-CSCF.

In order to initiate a call or other data session, the UE submits a SIP (session initiation protocol) INVITE message to the primary P-CSCF 110. The P-CSCF 110 identifies an I-CSCF in the home network of the UE and forwards the message to the I-CSCF. The I-CSCF locates an appropriate S-CSCF, which coordinates completion of the communication session.

When initiating a call, it may at times happen that one of the CSCFs is unavailable or unreachable. For example, a particular P-CSCF 110 may be unavailable and may not respond to requests by the UE 104. Unavailability of the P-CSCF may be due to equipment malfunctioning, maintenance activities, or network problems. As another example, the UE 104 may connect with the P-CSCF 110 but the P-CSCF may be unable to communicate with the I/S CSCF 112. In this case, the P-CSCF 110 may return an error message to the UE 104 indicating a failure to establish a session.

As mentioned above, the PGW/SGW 108 provides to the UE 104 an IP address of a primary P-CSCF 110, which will be referred to as the primary P-CSCF(1), and a IP address of a secondary P-CSCF 110, which will be referred to as the secondary P-CSCF(2). Note that other P-CSCF discovery mechanisms may also be available in certain networks.

When establishing a communication session, the UE 104 attempts to initiate the session first by communicating with the primary P-CSCF(1). In response to a situation in which the UE 104 is unable to establish a session through the primary P-CSCF(1), such as in response to a failure to receive a response from the primary P-CSCF(1) or in response to receiving an error message from the primary P-CSCF(1), the UE registers with the secondary P-CSCF(2) and tries to initiate the session by communicating with the secondary P-CSCF(2).

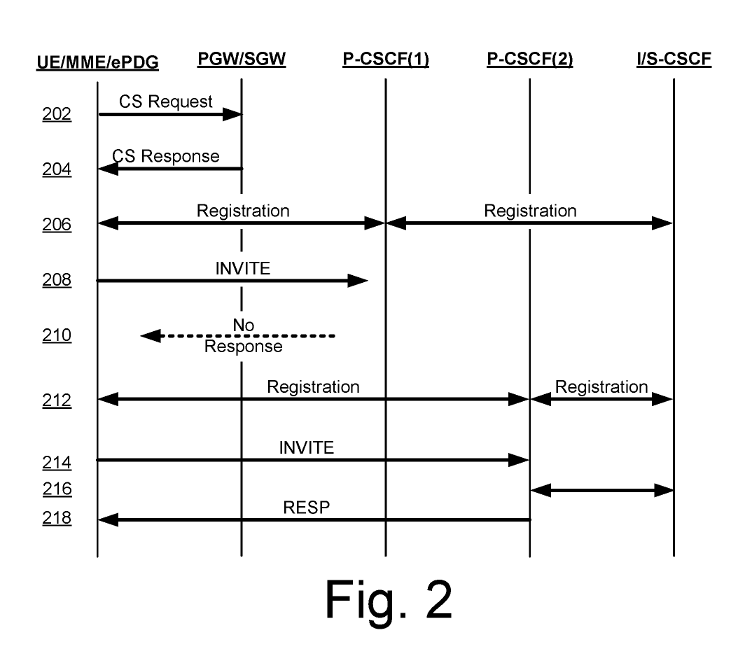

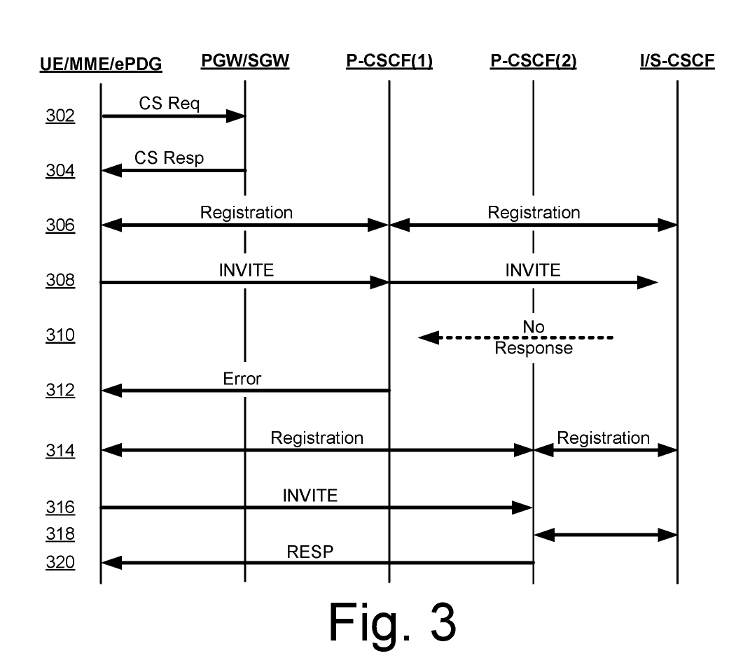

FIG. 2 illustrates a high-level call flow that may be implemented in certain embodiments for initiating call sessions from a UE. In FIG. 2, as well as in FIG. 3 which follows, communicating components or entities are listed along the top, with a corresponding vertical line extending downward. Communications are indicated by arrows that extend from and to the vertical lines corresponding to the entities from which the communications originate and terminate, respectively. Communications occur in order from top to bottom. An individual communication or set of communications is indicated by a corresponding reference numeral along the left side of the figure, horizontally aligned with the arrow or arrows representing the communication. Note that FIGS. 2 and 3 illustrate the most relevant communications and may omit other communications that occur in practice but are less relevant to the topics at hand Such other communications may include communications that both precede and follow the illustrated communications, communications that occur in time between the illustrated communications, and communications that occur between components or entities that are not specifically shown.

At 202, the UE communicates with the PGW/SGW by sending a create session (CS) request to the PGW/SGW. The request, while originating with the UE, may pass through or be based on information provided by the LTE MME and/or ePDG. In response, the PGW/SGW creates a bearer and allocates an IP address for the UE. In addition, the PGW/SGW identifies the primary P-CSCF(1) and the secondary P-CSCF(2) that are to be used by the UE.

At 204, the PGW/SGW responds with a CS response, indicating that a bearer has been established for the UE. The CS response specifies the IP address assigned to the UE as well as the IP addresses of the primary P-CSCF(1) and the IP address of the secondary P-CSCF(2).

At 206, the UE registers with the primary P-CSCF(1), and in turn the P-CSCF(1) completes a registration with the I/S-CSCF on behalf of the UE.

At 208, the UE sends a SIP INVITE message to the primary P-CSCF(1) in an attempt to initiate a call session. Specifically, the UE sends the SIP INVITE message to the IP address of the primary P-CSCF(1). However, the example of FIG. 2 assumes that the primary P-CSCF(1) has become unavailable and does not respond to the SIP INVITE message, as indicated by the dashed line at 210.

At 212, after receiving no response from the primary P-CSCF(1), the UE registers with the secondary P-CSCF(2), and in turn the secondary P-CSCF(2) completes a registration with the I/S-CSCF on behalf of the UE.

At 214, the UE then sends a second SIP INVITE message to the secondary P-CSCF(2) in a repeated attempt to initiate a call session. At 216, the secondary P-CSCF(2) communicates with the I/S-CSCF to complete the session setup. At 218, the secondary P-CSCF(2) returns a SIP RESP message to the UE, indicating that the session has been set up.

FIG. 3 illustrates another example of a call flow that may be implemented in certain embodiments for initiating call sessions from a UE. At 302, the UE communicates with the PGW/SGW by sending a create session (CS) request to the PGW/SGW. In response, the PGW/SGW creates a bearer and allocates an IP address for the UE. In addition, the PGW/SGW identifies the primary P-CSCF(1) and the secondary P-CSCF(2) that are to be used by the UE.

At 304, the PGW/SGW responds with a CS response, indicating that a bearer has been established for the UE. The CS response specifies the IP address of the UE as well as the IP addresses of the primary P-CSCF(1) and the secondary P-CSCF(2).

At 306, the UE registers with the primary P-CSCF(1), and in turn the P-CSCF(1) completes a registration with the I/S-CSCF on behalf of the UE.

At 308, the UE sends a SIP INVITE message to the primary P-CSCF(1) in an attempt to initiate a call session. In response, the primary P-CSCF(1) attempts to communicate with the I/S-CSCF to complete the session setup. In the example of FIG. 3, it is assumed that the primary P-CSCF(1) is unable to communicate with the I/S-CSCF, as indicated by the dashed line at 310, or that the I/S-CSCF returns an error. The primary P-CSCF(1) then sends an error message to the UE at 312, indicating a problem with setting up the requested data session.

At 314, in response to receiving the error message from the primary P-CSCF(1), UE registers with the secondary P-CSCF(2), and in turn the secondary P-CSCF(2) completes a registration with the I/S-CSCF on behalf of the UE.

At 316, the UE then sends a second SIP INVITE message to the secondary P-CSCF(2) in a repeated attempt to initiate a call session. At 318, the secondary P-CSCF(2) communicates with the I/S-CSCF to complete the session setup. At 320, the secondary P-CSCF(2) returns a SIP RESP message to the UE, indicating that the session has been set up.

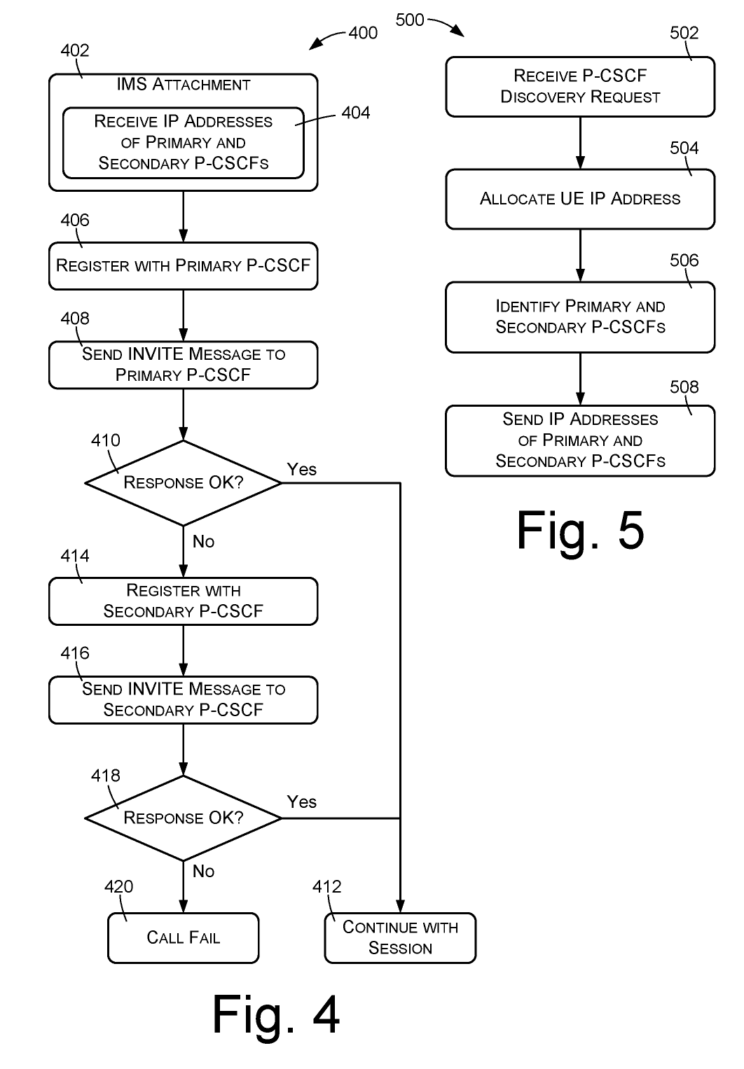

FIG. 4 shows an example method 400 that may be performed by a communication device, referred to herein as a UE, to initiate a data session through an IMS system.

An action 402 comprises performing an attachment procedure with the LTE network of which the IMS system is a part. This may comprise sending an attach request to the MME (mobility management entity) of the LTE infrastructure, or to the PGW of the IMS system. In response, the MME interacts with various other entities to determine the appropriate PGW and SGW, and to establish a default bearer. The PGW identifies the appropriate primary and secondary P-CSCFs. The action 402 may include a create session (CS) request to the PGW of the IMS system.

An action 404 comprises receiving an identification of the primary P-CSCF and an identification of the secondary P-CSCF. This may comprise receiving a CS response message from the PGW indicating the IP addresses of the primary and secondary P-CSCFs. The UE may also receive its own allocated IP address as part of the attachment procedure.

An action 406 comprises registering with the primary P-CSCF.

An action 408 and subsequent actions are performed in order initiate a data session with another UE. The action 408 comprises sending a SIP INVITE message to the P-CSCF, requesting that the IMS system set up and initiate a call session or other communication session using IMS services.

An action 410 comprises determining whether a success or “OK” response is received from the primary P-CSCF in response to the SIP INVITE message. If a success or “OK” message is received, an action 412 is performed, which comprises continuing with the requested session or session setup.

If a success or “OK” message is not received from the primary P-CSCF in response to the SIP INVITE message, indicating an error in initiating the communication session, an action 414 is performed. The action 414 comprises registering with the secondary P-CSCF.

An action 416 is then performed of sending a SIP INVITE message to the secondary P-CSCF, requesting again that the IMS system set up a communication session using IMS services.

The “No” branch of the decision 410 may correspond to a failure to receive any response to the SIP INVITE message from the primary P-CSCF. Alternatively, the “No” branch of the decision 410 may correspond to receiving an error message from the primary P-CSCF in response to the SIP INVITE message.

An action 418 comprises determining whether a success or “OK” response is received from the secondary P-CSCF in response to the SIP INVITE message. If a success or “OK” message is received, the action 412 is performed, which comprises continuing with the requested session or session setup. Otherwise, if a success or “OK” message is not received from the secondary P-CSCF in response to the SIP invite message, an action 420 is performed, indicating that the call request has failed.

FIG. 5 illustrates an example method 500 that may be performed by components of an IMS ad part of a device attachment procedure.

An action 502 comprises receiving a P-CSCF discovery request from the UE. In response, and action 504 comprises allocating an IP address for use by the requesting UE device. An action 506 comprises identifying a primary P-CSCF and a secondary P-CSCF for use by the requesting UE. An action 508 comprises sending the UE's IP address, the IP address of the primary P-CSCF, and the IP address of the secondary P-CSCF to the UE.

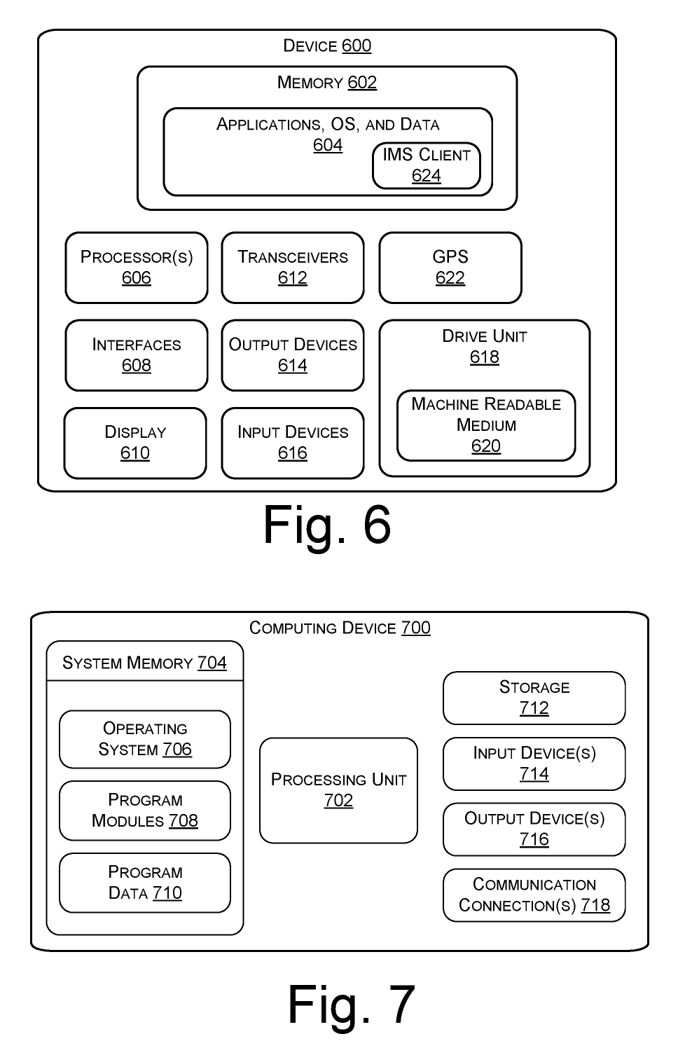

FIG. 6 illustrates an example communication device 600 in accordance with various embodiments. The device 600 is illustrative of the UE 104 of FIG. 1.

The device 600 may include a memory 602, which may store applications, an operating system (OS), and data 604. The device 600 further includes processor(s) 606, interfaces 608, a display 610, radio transceivers 612, output devices 614, input devices 616, and a drive unit 618 including a machine readable medium 620.

In various embodiments, the memory 602 includes both volatile memory and non-volatile memory. The memory 602 can also be described as non-transitory computer storage media and may include removable and non-removable media implemented in any method or technology for storage of information, such as computer readable instructions, data structures, program modules, or other data. The applications, OS, and data 604 are stored in the memory 602. Additionally, in some embodiments, the memory 602 may include a SIM (subscriber identity module), which is a removable smart card used to identify a user of the device 600 to a service provider network.

Non-transitory computer-readable media may include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the device 600. Any such non-transitory computer-readable media may be part of the device 600.

In some embodiments, the processor(s) 606 is a central processing unit (CPU), a graphics processing unit (GPU), or both CPU and GPU, or other processing unit or component known in the art.

In various embodiments, the interfaces 608 are any sort of interfaces known in the art. The interfaces 608 may include any one or more of an Ethernet interface, wireless local-area network (WLAN) interface, a near field interface, a DECT chipset, or an interface for an RJ-11 or RJ-45 port. A wireless LAN interface can include a Wi-Fi interface or a Wi-Max interface, or a Bluetooth interface that performs the function of transmitting and receiving wireless communications using, for example, the IEEE 702.11, 702.16 and/or 702.20 standards. The near field interface can include a Bluetooth® interface or radio frequency identifier (RFID) for transmitting and receiving near field radio communications via a near field antenna. For example, the near field interface may be used for functions, as is known in the art, such as communicating directly with nearby devices that are also, for instance, Bluetooth® or RFID enabled.

In various embodiments, the display 610 may comprise a liquid crystal display or any other type of display commonly used in telecommunication devices or other portable devices. For example, the display 610 may be a touch-sensitive display screen, which may also act as an input device or keypad, such as for providing a soft-key keyboard, navigation buttons, or the like.

In some embodiments, the transceivers 612 include any sort of transceivers known in the art. For example, the transceivers 612 may include radio radios and/or radio transceivers and interfaces that perform the function of transmitting and receiving radio frequency communications via an antenna, through a cellular communication network of a wireless data provider. The radio interfaces facilitate wireless connectivity between the device 600 and various cell towers, base stations and/or access points.

In some embodiments, the output devices 614 include any sort of output devices known in the art, such as a display (already described as display 610), speakers, a vibrating mechanism, or a tactile feedback mechanism. The output devices 614 also include ports for one or more peripheral devices, such as headphones, peripheral speakers, or a peripheral display.

In various embodiments, the input devices 616 include any sort of input devices known in the art. For example, the input devices 616 may include a microphone, a keyboard/keypad, or a touch-sensitive display (such as the touch-sensitive display screen described above). A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

The device 600 may also have a GPS (global positioning system) receiver 622 for determining the current location of the device 600 based on signals received from satellites.

The machine readable medium 620 stores one or more sets of instructions (e.g., software) such as a computer-executable program that embodies operating logic for implementing and/or performing any one or more of the methodologies or functions described herein. The instructions may also reside, completely or at least partially, within the memory 602 and within the processor 606 during execution thereof by the device 600. The memory 602 and the processor 606 also may constitute machine readable media 620.

In some embodiments, the Applications, OS, and data 604 may include an IMS client 624, which may comprise an application or other software components for performing communications in the manner described above.

FIG. 7 is a block diagram of an illustrative computing device 700 such as may be used to implement various components of the IMS infrastructure 102 including servers, routers, gateways, administrative components, etc.

In various embodiments, the computing device 700 may include at least one processing unit 702 and system memory 704. Depending on the exact configuration and type of computing device, the system memory 704 may be volatile (such as RAM), non-volatile (such as ROM, flash memory, etc.) or some combination of the two. The system memory 704 may include an operating system 706, one or more program modules 708, and may include program data 710.

The computing device 700 may also include additional data storage devices (removable and/or non-removable) such as, for example, magnetic disks, optical disks, or tape. Such additional storage is illustrated in FIG. 7 by storage 712.

Non-transitory computer storage media of the computing device 700 may include volatile and nonvolatile, removable and non-removable media implemented in any method or technology for storage of information, such as computer readable instructions, data structures, program modules, or other data. The system memory 704 and storage 712 are all examples of computer-readable storage media. Non-transitory computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such non-transitory computer-readable storage media may be part of the computing device 700.

In various embodiment, any or all of the system memory 704 and storage 712 may store programming instructions which, when executed, implement some or all of the function functionality described above as being implemented by components of the IMS infrastructure 102, such as a PGW, an SGW, a P-CSCF, an I-CSCF, an S-CSCF, and other components of the infrastructure 102.

The computing device 700 may also have input device(s) 714 such as a keyboard, a mouse, a touch-sensitive display, voice input device, etc. Output device(s) 716 such as a display, speakers, a printer, etc. may also be included. The computing device 700 may also contain communication connections 718 that allow the device to communicate with other computing devices.

Although features and/or methodological acts are described above, it is to be understood that the appended claims are not necessarily limited to those features or acts. Rather, the features and acts described above are disclosed as example forms of implementing the claims.

What is claimed is:

1. A method comprising:
receiving an identification of a first proxy call session control function (P-CSCF) of an IP multimedia subsystem (IMS);
receiving an identification of a second P-CSCF of the IMS;
sending a first session initiation protocol (SIP) message to the first P-CSCF to initiate a call session using IMS services;
determining that there is an error in initiating the call session; and
sending a second SIP message to the second P-CSCF to initiate the call session using the IMS services.

2. The method of claim 1, wherein determining that there is an error in initiating the call session comprises failing to receive a response to the first SIP message.

3. The method of claim 1, wherein determining that there is an error in initiating the call session comprises receiving a response from the first P-CSCF indicating an error.

4. The method of claim 1, further comprising communicating with a packet data network gateway (PGW) of the IMS to receive the identification of the first P-CSCF and to receive the identification of the second P-CSCF.

5. The method of claim 1, further comprising:
sending a create session request to a packet data network gateway (PGW) of the IMS; and
receiving a create session response from the PGW, the create session response specifying the identification of the first P-CSCF and the identification of the second P-CSCF.

6. The method of claim 1, wherein the SIP message comprises a SIP INVITE message.

7. The method of claim 1, wherein:
receiving the identification of the first P-CSCF comprises receiving an IP address of the first P-CSCF; and
receiving the identification of the second P-CSCF comprises receiving an IP address of the second P-CSCF.

8. The method of claim 1, further comprising registering with the first P-CSCF prior to sending the first SIP message to the first P-CSCF.

9. A communication device comprising:
one or more processors;
one or more non-transitory computer-readable media storing computer-executable instructions that, when executed on the one or more processors, cause the one or more processors to perform actions comprising:
communicating with an IP multimedia subsystem (IMS) to receive an identification of a first proxy call session control function (P-CSCF) and an identification of a second P-CSCF;
sending a first message to the first P-CSCF to initiate a call session;
determining that there is an error in initiating the call session; and
sending a second SIP message to the second P-CSCF to initiate the call session.

10. The communication device of claim 9, wherein determining that there is an error in initiating the call session comprises failing to receive a response to the first SIP message.

11. The communication device of claim 9, wherein determining that there is an error in initiating the call session comprises receiving a response from the first P-CSCF indicating an error.

12. The communication device of claim 9, the actions further comprising:
sending a create session request to a packet data network gateway (PGW) of the IMS; and
receiving a create session response from the PGW, the create session response specifying the identification of the first P-CSCF and the identification of the second P-CSCF.

13. The communication device of claim 9, wherein the SIP message comprises a SIP INVITE message.

14. One or more non-transitory computer storage media with a stored computer-executable program, which, when executed by one or more processors of a first device, performs actions comprising:
receiving an identification of a first proxy call session control function (P-CSCF) of an IP multimedia system (IMS);
receiving an identification of a second P-CSCF of the IMS;
sending a first session initiation protocol (SIP) message to the first P-CSCF to initiate an IMS session;
determining that there is an error in initiating the IMS session; and
sending a second SIP message to the second P-CSCF to initiate the IMS session.

15. The one or more non-transitory computer storage media of claim 14, wherein determining that there is an error in initiating the IMS session comprises failing to receive a response to the first SIP message.

16. The one or more non-transitory computer storage media of claim 14, wherein determining that there is an error in initiating the IMS session comprises receiving a response from the first P-CSCF indicating an error.

17. The one or more non-transitory computer storage media of claim 14, the actions further comprising communicating with a packet data network gateway (PGW) of the IMS to receive the identification of the first P-CSCF and to receive the identification of the second P-CSCF.

18. The one or more non-transitory computer storage media of claim 14, wherein the SIP message comprises a SIP INVITE message.

19. The one or more non-transitory computer storage media of claim 14, wherein:
receiving the identification of the first P-CSCF comprises receiving an IP address of the first P-CSCF; and
receiving the identification of the second P-CSCF comprises receiving an IP address of the second P-CSCF.

20. The one or more non-transitory computer storage media of claim 14, the actions further comprising registering with the first P-CSCF prior to sending the first SIP message to the first P-CSCF.
